(19) United States
(12) Patent Application Publication
(10) Pub. No.: US 2003/0046267 A1
(43) Pub. Date: Mar. 6, 2003

(54) Image retrieving method and device

(76) Inventors: Yoshinori Musha, Kokubunji (JP); Atsushi Hiroike, Kawagoe (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/046,980

(22) Filed: Jan. 17, 2002

(30) Foreign Application Priority Data
Jan. 22, 2001 (JP) 2001-012615

(51) Int. Cl. G06F 7/00

(52) U.S. Cl. 707/1

(57) ABSTRACT

A user's action of depicting a vision is closely associated with image retrieval. Images are selected with each stroke made in order to paint a color or a draw a line on a canvas at a step of creating a retrieval key. The resultant images and corresponding areas within the images are presented to a user. Thus, the user can create the retrieval key while looking at the results of retrieval. Owing to this technique, even a person who is poor at drawing a picture can retrieve images as if to draw a picture. One attribute information or a plurality of attribute information items is selected from among attribute information items prepared in advance. The attribute information is assigned to a designated area. Images having area-attribute information produced using the attribute information in combination with information specifying the area are retrieved from an image database, and then provided. Moreover, corresponding areas within the retrieved images in which attribute information common to the retrieved images is found are detected. The corresponding areas within the retrieved images are displayed in a corresponding area on a display device.

### BACKGROUND OF THE INVENTION

1. Field of the Invention

The present invention relates to an image retrieving method and device for providing images as the results of retrieval. More particularly, the present invention is concerned with a method and device for retrieving an image using attribute information specific to an area within the image, and with an image database creating method and device.

2. Description of the Related Art

As a method for fetching a desired image from an image database using the similarity of the image to the others, a method of acquiring an image similar to a retrieval key, which is the image itself, from a database is known. Moreover, there are known a method of creating a retrieval key by drawing a sketch or using simple graphics in combination, and then retrieving a desired image using the retrieval key, and a method of displaying features extracted from an image on a screen, selecting any of the image features, and then retrieving a desired image.

In the retrieving method using an image itself as a retrieval key, if retrieval is performed even once, retrieved images are displayed. A retrieval key to be adopted next can be selected from among the displayed images. For the first retrieval at the time of which no retrieved image is displayed, how to designate a retrieval key is a question. In the method of creating a retrieval key by drawing a sketch, any picture can be drawn. However, drawing a picture is labor-intensive. The method is discouraging to a person who is poor at drawing a picture. Moreover, if a desired image is not retrieved, it is uncertain whether the reason why a desired image has not been retrieved lies in that the sketch used as a retrieval key is badly drawn or that the image is absent from the database. In the method of creating a retrieval key by combining simple graphics, it is easy to create a retrieval key. However, the simple graphics must be combined in order to depict a vision. Moreover, the correspondence of the created retrieval key with images that are the results of retrieval is not exactly what a user intends to be. Talking of the method of selecting any of the image features on the screen, if a pattern on a material or a texture itself is a primary feature of an image to be retrieved, the method would prove effective. If the composition of an image has a significant meaning, it is quite hard to select images, which are drawn with great freedom, by presenting the composition as features. Thus, a common problem underlies the related arts. Namely, a user's desired vision cannot be fully reflected on a retrieval key at a step of selecting or creating the retrieval key, or the correspondence of the result reflected on the retrieval key with the results of retrieval is unclear.

### SUMMARY OF THE INVENTION

Accordingly, an object of the present invention is to provide a technique allowing a user to create a retrieval key while looking at the results of retrieval. Specifically, a user's action of depicting a vision is closely associated with image retrieval. Images are selected with each stroke made in order to paint a color or draw a line on a canvas at a step of creating a retrieval key. The resultant images are presented to the user.

According to the present invention, one attribute information or a plurality of attribute information items is selected from among attribute information prepared in advance. The attribute information is assigned to a designated area. Images having area-attribute information produced using the attribute information in combination with information specifying the area are retrieved from an image database, and then provided. Moreover, corresponding areas within the retrieved images in which attribute information common to the retrieved images is found are detected. The corresponding areas within the retrieved images are displayed in a corresponding area on a display device. Furthermore, a range of retrieval may be narrowed by assigning one attribute information or a plurality of attribute information items to one area or a plurality of areas to which attribute information has not been assigned. Otherwise, the range of retrieval may be narrowed by adding one attribute information or a plurality of attribute information items to one area or a plurality of areas to which attribute information has already been assigned. Otherwise, the range of retrieval may be expanded by deleting one attribute information or a plurality of attribute information items from one area or a plurality of areas to which attribute information has already been assigned. Otherwise, the range of retrieval may be narrowed by assigning the same attribute information or attribute information items as one attribute information or a plurality of attribute information items, which is found in an area to which attribute information has already been assigned, to another area. Otherwise, the range of retrieval may be changed by changing the assignee of one attribute information or a plurality of attribute information items, which is found in an area to which attribute information has already been assigned, into another area. Thus, the range of retrieval can be changed.

These and other objects of the present invention, and the features and advantages thereof will be more apparent from the description of the preferred embodiments in conjunction with the accompanying drawings.

### BRIEF DESCRIPTION OF THE DRAWINGS

FIG. 1 shows a graphical user interface (GUI);

FIG. 2 is concerned with a method of producing area-attribute information concerning colors;

FIG. 3 is concerned with a method of producing area-attribute information concerning a line and a shape;

FIG. 4 shows an example of attribute information;

FIG. 5 is concerned with a method of retrieving an image and a method of detecting common area-attribute information;

FIG. 6 shows a procedure of displaying common area-attribute information;

FIG. 7 is concerned with a procedure of manipulating data on a canvas;

FIG. 8 is concerned with a method of creating an image-and-area-attribute database; and

FIG. 9 is a flow of data transferred during one retrieval.

### DESCRIPTION OF THE PREFERRED EMBODIMENTS

A preferred embodiment of the present invention will be described with reference to the appended drawings below.

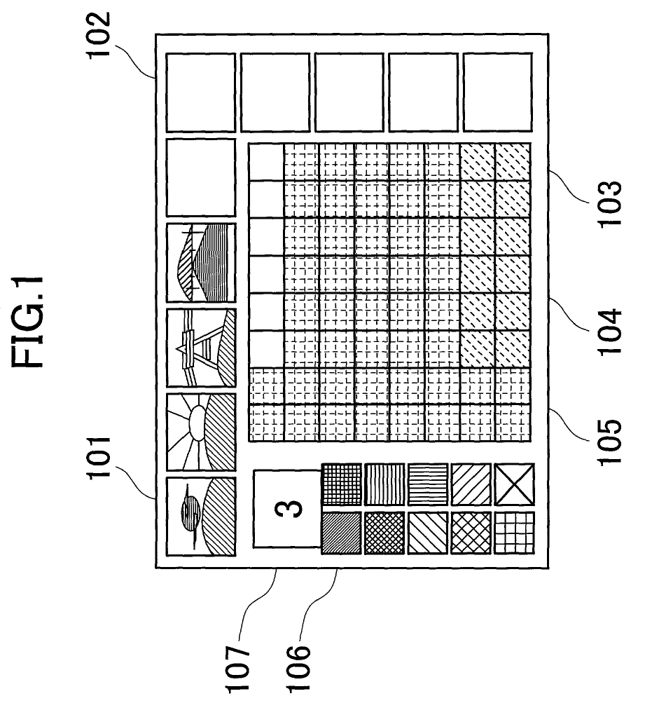

FIG. 1 illustratively shows a graphic user interface (GUI) employed in the present embodiment. By painting a color on a canvas or drawing a line or a shaped thereon, images are dynamically retrieved based on a composition. Selected candidates for the images are presented. Initially, a field 105 having nothing drawn therein expands over a canvas 103. A user selects a color or a line from a palette 106, and draws a picture on the canvas. When a color is selected, the color is treated as attribute information as it is. When a line is selected, a shape drawn with the line is treated as attribute information. The attribute information is combined with information specifying an area in which the color is painted or the line is drawn, and the resultant information is treated as area-attribute information, whereby image retrieval is carried out. Images 101 that are the results of retrieval are presented to the user by an image display 102. Thereafter, if the retrieved images have common attribute information found in corresponding areas thereof, the corresponding areas of the retrieved images are synthesized and displayed. Consequently, part of an image is displayed in, for example, an area 104. All retrieved images cannot always be displayed on the image display 102. The number of images selected so far is presented by a number-of-images indicator 107.

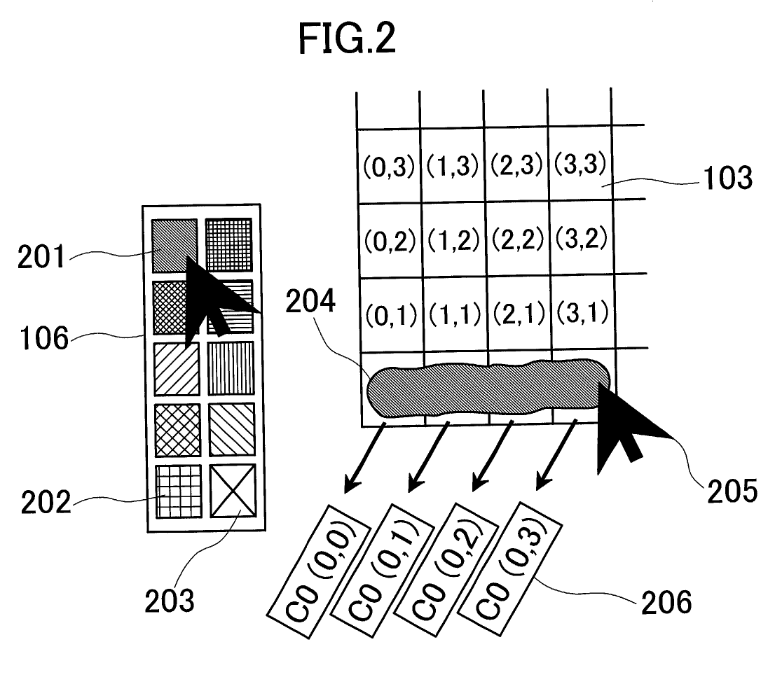

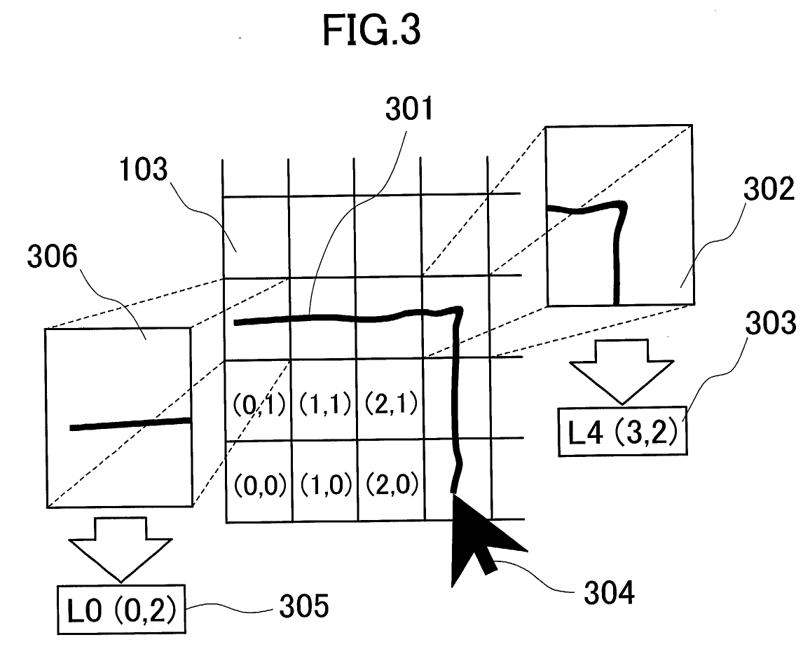

FIG. 2 is an illustrative drawing concerned with a method of producing area-attribute information when a color is selected from the palette 106 and pained on the canvas 103. A user selects a color 201 from the palette 106, and makes a stroke 204 on the canvas 103. The canvas 103 is divided into areas. An index specifying an area, such as, (1, 2) is assigned to each area. Assume that it is detected using the GUI that the color 201 is painted over areas (0, 0) , (0, 1) , (0, 2) , and (0, 3) in that order using a mouse cursor 205. Area-attribute information items 206 of C0(0, 0), C0(0, 1), C0(0, 2), and CO(0, 3) are produced with the progress of the painting. Images having the area-attribute information items 206 are retrieved from an area-attribute information database, and provided. To be more specific, when the stroke 204 made by the user passes through the area (0,0), the area-attribute information C0(0, 0) is produced, and images having the area-attribute information are retrieved. Thereafter, when the stroke passes through the area (0, 1), the area-attribute information C0(0, 1) is produced. Images having the area-attribute information C0 (0, 1) are selected from the previously retrieved images. Likewise, images having the area-attribute information items C0(0, 2) and C0(0, 3) are selected. While the user makes a stroke, images are selected step by step. If a keyword can be designated as attribute information, the keyword is substituted for the aforesaid color. A keyword is assigned to each area, whereby image retrieval is carried out. Moreover, when an eraser 203 is selected from the palette 106, the mouse cursor is passed through an area to which attribute information has already been assigned. Consequently, the area-attribute information is deleted. Eventually, a range of retrieval can be expanded. A drawing 202 on the palette 106 will be described in conjunction with FIG. 3.

FIG. 3 is an illustrative drawing concerned with a method of producing area-attribute information when a line is selected from the palette 106 in order to make a drawing on the canvas 103. A user selects the drawing 202 shown in FIG. 2 from the palette 106, and uses the mouse cursor 304 to draw a hook-shaped line 301 on the canvas 103. What drawing is made in each of the areas over which the user has made the drawing is detected using the GUI, and attribute information is selected. Furthermore, the attribute information is combined with area information, thus producing area-attribute information. Specifically, when a stroke 306 made by a user passes through an area (0, 2), a drawn line is judged to be a horizontal line and attribute information L0 is selected. Consequently, area-attribute information L0(0, 2) 305 is produced. Likewise, when a stroke 302 is made to draw a hook in an area (3, 2) , attribute information L4 is selected and area-attribute information L4(3, 2) 302 is produced. Image retrieval is performed in the same manner as that is when a color is painted as shown in FIG. 2.

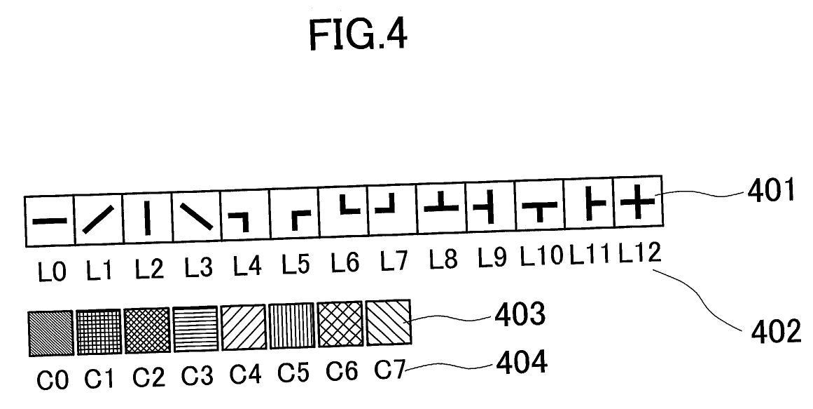

FIG. 4 shows an example of attribute information. Drawings 401 are detected as attributes, and attribute information items 402 represent the attributes. Colors 403 are detected as attributes, and attribute information items 404 represent the attributes. A drawing made by a user is, unlike the drawings 401 taken as an example, not always right-angled. The slope of a drawing is therefore quantized, whereby the drawing is classified into a pattern whose slope is similar to the slope of the drawing. If a drawing is similar to a plurality of patterns to the same extent, the drawing is classified into all the patterns. As for patterns represented by attribute information items to be detected, 13 patterns represent the shapes or drawings 401, and 8 patterns represent the colors 403. The number of patterns may be increased with an increase in the number of slopes to be quantized or the number of tones. In contrast, the number of patterns may be decreased with a decrease in the number of categories such as the slopes or tones. In either case, the number of patterns is determined at the time of designing a database of area-attribute information.

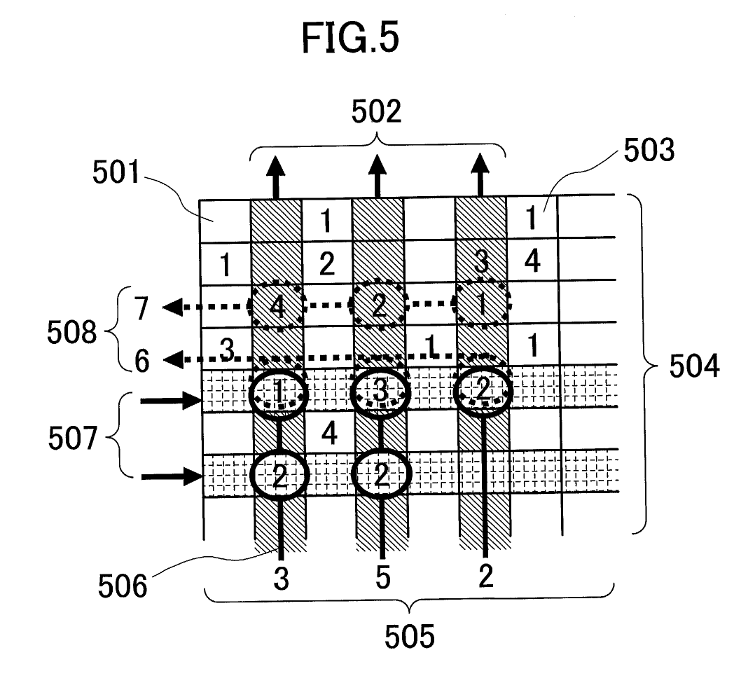

FIG. 5 is an illustrative drawing concerned with a method of retrieving images from an area-attribute information database and a method of detecting common area-attribute information. An area-attribute information database has a matrix structure 501, wherein rows 504 indicate identifiers (IDs) of area-attribute information items, and columns 505 indicate IDs of images. The elements 503 of the matrix structure 501 represent the degrees of validity to which each image would prove valid when retrieved based on each area-attribute information. The larger the element value is, the more worthwhile it is to retrieve the image. Assume that a user has drawn a line and two area-attribute information items 507 have been produced accordingly. Element values assigned to each image are added up as indicated with reference numeral 506. Images 502 relative to which the sums of assigned element values are 3, 5, and 2 larger than 0 are provided as the results of retrieval. If the results of retrieval are sorted in descending numerical order, the most worthwhile image is provided first. Thus, retrieval is carried out. Element values assigned to images associated with two area-attribute information items 507 may be weighted with the degree of conformity to attribute information entered using the GUI, and then added up image by image, though this is not shown in FIG. 5.

In order to detect common area-attribute information, area-attribute information items exhibited by all images 502 are detected, and element values are added up in units of area-attribute information. This results in the sums 508 of 7 and 6. In this case, the areas within the images 502 which have each of the area-attribute information items may be synthesized to produce a synthetic image and the synthetic image may be displayed. Otherwise, the areas within the images 502 may be displayed while being sequentially switched. Thus, the results of retrieval may be presented to a user. A threshold may be defined for the sums 508. If a sum is smaller than the threshold, the sum may be ignored. On the contrary, although corresponding areas within retrieved images do not have a common attribute, if areas within as many retrieved images as possible have a common attribute, the images may be provided.

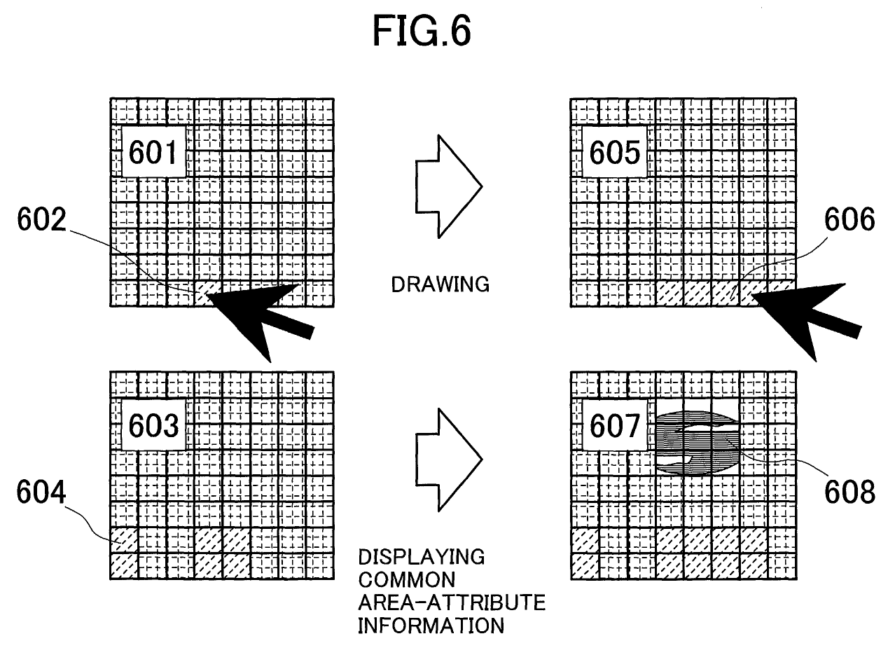

FIG. 6 is an illustrative drawing for explaining a procedure for displaying detected common area-attribute information using the GUI. FIG. 6 demonstrates that as a user assigns attribute information to areas, more and more areas within images to be retrieved have common attribute information. In an input situation 601, a user assigns a color attribute to an area 602. At this time, corresponding areas within the images to be retrieved are detected to have a common attribute. In an output situation 603, therefore, the corresponding areas within the images to be retrieved are displayed in corresponding areas 604 other than the area which the user has designated. In an input situation 605, the number of areas which the user has designated increases as indicated with reference numeral 606. Images to be retrieved as the results of retrieval are selected, whereby the number of images decreases. Corresponding areas within the images to be retrieved in which a common attribute is found can be detected easily. In an output situation 607, many corresponding areas within the images to be retrieved in which a common attribute is found are displayed in corresponding areas 608.

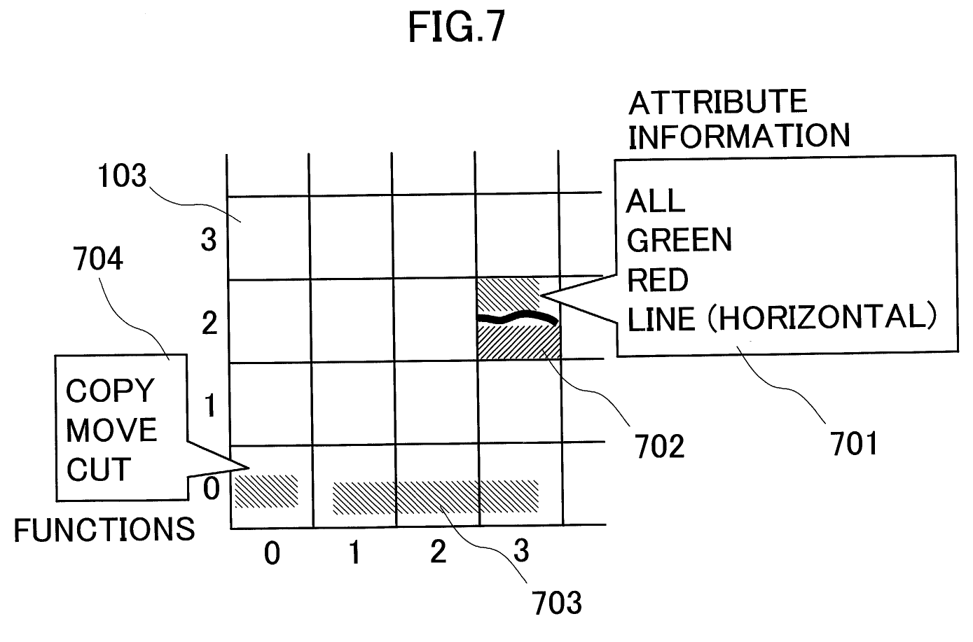

FIG. 7 is an illustrative drawing for explaining the functions of the GUI to be used to manipulate attribute information on the canvas 103. The mouse cursor is moved to an area such as an area 702 to which attribute information has already been assigned. When the right button of a mouse is clicked, a pop-up menu 701 appears. A list of attribute information items assigned to the area is presented. All signifies that all the attributes are selected. Green and Red represent color attributes, and Line (horizontal) represents a line or shape attribute. If a keyword can be used as attribute information, if a keyword is assigned to the area 702, the keyword is presented together with the other attributes by the pop-up menu 701. Herein, if any menu item is selected, a list of functions selectable for the area 702 appears as a pop-up menu 704 within the area 702. Herein, Copy and Move signify that selected attribute information is copied or moved to another area 703 to which the mouse cursor is moved. Cut signifies that the selected attribute information is deleted from the area.

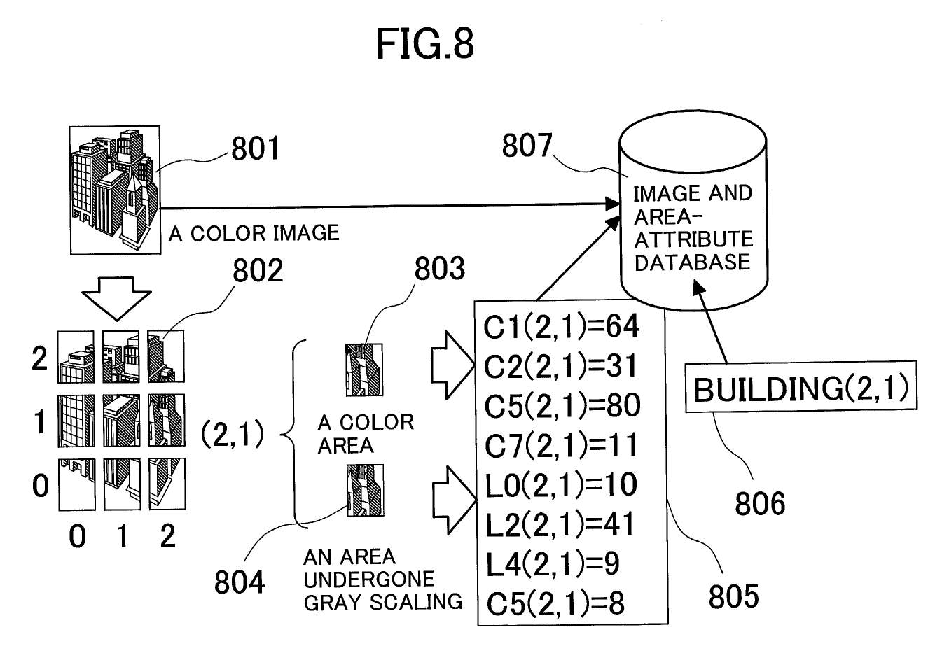

FIG. 8 is an illustrative drawing for explaining a mechanism of creating an image-and-area-attribute database composed of an image database and an area-attribute information database. First, images to be retrieved are prepared, extracted one by one, and manipulated as described below. An image 801 is divided into a plurality of areas 802. For brevity's sake, the image 801 is divided into areas arrayed in three rows and three columns. Among the areas, one area 803 is extracted and processed in the form of a color image. A plurality of color attributes C1, C2, C5, and C7 is extracted and combined with an index (2, 1) specifying the area, whereby area-attribute information 805 is produced. Moreover, a plurality of shape attributes L0, L2, L4, and L5 is extracted from an area 804 that has undergone gray scaling, whereby area-attribute information 805 is produced. Moreover, area-attribute information 806 is produced using a keyword as attribute information. As the area-attribute information, a ratio at which an attribute occupies an area, a frequency by which an area-attribute appears in all images in an image-and-area-attribute database to be retrieved, or a value proportional to the rareness of the area-attribute information to all the information items recorded in an area-attribute information database (an amount of information) can be adopted. The thus produced area-attribute information is recorded in the image-and-area-attribute database 807 in association with an image ID.

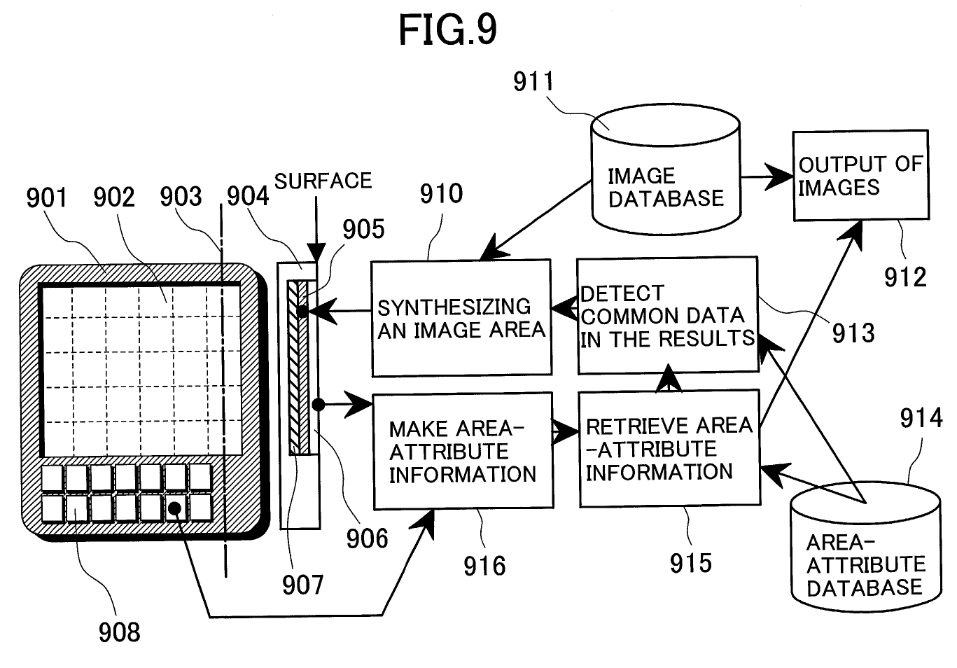

FIG. 9 is an illustrative drawing for explaining a display input device and a block diagram showing a flow of data. A display input device 901 is a manipulation pad composed of a canvas 902 on which a user draws a picture, a display device on which image areas are displayed, and buttons 908 arranged as a palette. A sectional view 904 shows a plane cut along a dot-dash line 903. In the sectional view 904, the surface of the display input device 901 is shown as the right-hand side thereof. A transparent switch 906 to be used to draw a picture, a liquid crystal display 905, and a backlight 907 are layered in that order from the surface of the display input device.

One retrieval is carried out according to a sequence described below. The transparent switch 906 is used to enter area information, and the buttons 908 are used to enter attribute information. An area-attribute information producing unit 916 produces area-attribute information. An area-attribute retrieving unit 915 uses the area-attribute information to search an area-attribute database 914 that has a matrix structure, and provides image IDs. The image IDs are transferred to an output unit 912 that provides images. Images specified with the image IDs are actually retrieved from an image database 911, and displayed on an output device that presents images. The image IDs are also transferred to a common area-attribute detecting unit 913. Consequently, area-attribute information that is common to the results of retrieval is extracted using the area-attribute database 914. An image area synthesizing unit 910 retrieves areas with images, in which the common area-attribute information is found, from the image database, synthesizes them, and displays a synthetic image on the liquid crystal display 905.

According to the present invention, while a retrieval key is created on a canvas, areas within images recorded in a database appear in corresponding areas on the canvas. When the retrieval key has been created, retrieval is completed. Consequently, retrieval can be performed as if to draw a picture using the images recorded in the database.

The present invention has been described above in conjunction with the preferred embodiment. A person with an ordinary skill in the art would be able to make various modifications of the embodiments without a departure from the scope and spirit of the invention. The present invention will be defined with the appended claims.

What is claimed is:

1. An image retrieving method for providing images as the results of retrieval, comprising the steps of:
prompting a user to select one attribute information or a plurality of attribute information items from attribute information items prepared in advance and to assign the selected attribute information to a designated area; and
retrieving images, which have area-attribute information produced using the attribute information in combination with information specifying the area, from an image database and providing the retrieved images.

2. A retrieving method for providing images as the results of retrieval, comprising the steps of:
detecting corresponding areas within retrieved images in which attribute information common to the retrieved images is found; and
displaying the detected corresponding areas within the images in corresponding areas on an output display means on which the images are displayed or represented.

3. An image retrieving method according to claim 1, wherein a range of retrieval is changed by performing any of the following manipulations:
a manipulation of narrowing the range of retrieval by assigning one attribute information or a plurality of attribute information items to one area or a plurality of areas to which attribute information has not been assigned; a manipulation of narrowing the range of retrieval by adding one attribute information or a plurality of attribute information items to one area or a plurality of areas to which attribute information has already been assigned;
a manipulation of expanding the range of retrieval by deleting one attribute information or a plurality of attribute information items from one area or a plurality of areas to which attribute information has already been assigned;
a manipulation of narrowing the range of retrieval by assigning the same attribute information or attribute information items as one attribute information or a plurality of attribute information items, which is found in one area or a plurality of areas to which attribute information has already been assigned, to another area or another plurality of areas;
a manipulation of changing the range of retrieval by changing the assignee of one attribute information or a plurality of information items, which is found in one area or a plurality of areas to which attribute information has already been assigned, into another area or another plurality of areas; and
a manipulation of changing the range of retrieval by changing one attribute information or a plurality of attribute information items, which is found in one area or a plurality of areas to which attribute information has already been assigned, into another attribute information or another plurality of attribute information items.

4. An image retrieving method according to claim 1 or 3, wherein when a line, a shape, or a texture is drawn on an area specifying means that is used to assign attribute information to a designated area, attribute information representing the line oriented in the direction of drawing or attribute information representing the shape or texture is added to attribute information concerning an area within an image to be produced which corresponds to the area on the area specifying means in which the line, shape, or texture has been drawn.

5. An image database creating method for a database of image attribute information used to retrieve an image, comprising the steps of:
dividing an image into a plurality of areas, extracting image features from each area, and providing the image features as attribute information;
producing area-attribute information using the attribute information in combination with information specifying the area; and
recording the area-attribute information in a database in association with the image.

6. An image retrieving device comprising:
an attribute selecting means for selecting attribute information concerning an image area;
an area specifying means for assigning the attribute information to a designated area;
an area-attribute information database in which area-attribute information produced using the attribute information in combination with information specifying the area is recorded;
an image database in which image data to be provided is recorded;
an image retrieving means for retrieving images that have attribute information, which is selected by said attribute selecting means, found in the areas thereof corresponding to the area designated by said area specifying means; and
a means for displaying the retrieved images.

7. A retrieving device for providing images as the results of retrieval, comprising:
a common area-attribute detecting means for detecting corresponding areas within retrieved images in which attribute information common to the retrieved images is found; and
an image area displaying means for displaying or representing the corresponding areas within the retrieved areas in an area corresponding to the corresponding areas detected by said common area-attribute detecting means.

8. A retrieving device according to claim 7, wherein images selected by an image retrieving means are synthesized to produce a synthetic image, and an area within the synthetic image is displayed.

9. A retrieving device according to claim 7, wherein areas within images retrieved by an image retrieving means are displayed while being sequentially switched.

10. An image database creating device for creating a database of image attribute information used to retrieve images, comprising:
a feature extracting means for dividing an image into a plurality of areas, extracting image features from each area, and providing the image features as attribute information; and
an attribute recording means for producing area-attribute information using the attribute information in combination with information specifying the area, and recording the area-attribute information in a database in association with the image.

11. An image database creating device according to claim 10, wherein an image is displayed, any symbol or keyword is assigned to one area or a plurality of areas within the image, the symbol or keyword is combined with information specifying the area, and the resultant information is treated as area-attribute information set forth in claim 1.

12. A retrieving service for providing images in compliance with a user's request for retrieval, wherein:
a user is provided with an attribute selecting means for use in selecting attribute information and an area specifying means for use in designating an area;
the user is prompted to assign one attribute information or a plurality of attribute information items, which is selected from attribute information items prepared in advance, to a designated area; and
images having area-attribute information produced using the attribute information in combination with information specifying the area are retrieved from an image database and presented to the user.

13. A retrieving service for providing images in compliance with a user's request for retrieval, wherein:
corresponding areas within retrieved images in which attribute information common to the retrieved images is found are detected; and
a synthetic image of the corresponding areas within the retrieved images is displayed or the corresponding areas within the retrieved images are displayed while being sequentially switched.

14. A program instructing a computer to function as an image retrieving device, comprising:
a means for prompting a user to assign one attribute information or a plurality of attribute information items, which is selected from attribute information items prepared in advance, to a designated area;
a means for retrieving images, which have area-attribute information produced using the attribute information in combination with information specifying the area, from an image database; and
a means for providing retrieved images.

15. A program for instructing a computer to function as a database creating device for creating a database of image attribute information used to retrieve an image, comprising:
a means for dividing an image into a plurality of areas, extracting image features from each area, and providing the image features as attribute information;
a means for producing area-attribute information using the attribute information in combination with information specifying the area; and
a means for recording the area-attribute information in a database in association with the image.
